(19) United States
(12) Patent Application Publication
(10) Pub. No.: US 2011/0156362 A1
(43) Pub. Date: Jun. 30, 2011

(54) Multi-combed Self-pressurizing Pipe Coupling Seal

(76) Inventors: Michael Skellern, Irvine, CA (US); Keith Wyness, Neston (GB); Richard Ollerhead, Thorton Hough (GB)

(21) Appl. No.: 12/651,134

(22) Filed: Dec. 31, 2009

(51) Int. Cl. F16J 15/02

(52) U.S. Cl. 277/605; 277/602

(57) ABSTRACT

This self-pressurizing seal invention embodies resilient, non-corrosive and fire resistant construction with an internal pressure responsive chamber whereby fluids entering such chamber through a unidirectional fluid orifice are trapped in the internal chamber and whereby the resulting pressure differential causes outward expansion from the internal chamber to external sealing surface of multiple, pliable and conjoined ridges to form a series of redundant circumferential seals against the axial pipe surface with corresponding force to prevent the outward flow of fluids from the pipe juncture in a pipe coupling or valve.

### STATEMENT OF FEDERALLY SPONSORED RESEARCH/DEVELOPMENT

Not Applicable

### FIELD AND BACKGROUND OF THE INVENTION

This invention relates to the field of sealing pipes in couplings and pipes to valves in the oil and gas industry, pipeline construction, maritime, ship building, plumbing, air conditioning, food processing and other related industries. Prior devices and methods to join and seal pipes and valves have limitations and compromises in terms of installation complexity, seal performance, and overall costs which are directly related to pipe size, pipe material, fluid contents, line pressure, environment, equipment, labor skills required, installation time, seal testing and cost impact. These devices and methods include welding, brazing, leading,

### FIELD AND BACKGROUND OF THE INVENTION

This invention relates to the field of sealing pipes in couplings and pipes to valves in the oil and gas industry, pipeline construction, maritime, ship building, plumbing, air conditioning, food processing and other related industries. Prior devices and methods to join and seal pipes and valves have limitations and compromises in terms of installation complexity, seal performance, and overall costs which are directly related to pipe size, pipe material, fluid contents, line pressure, environment, equipment, labor skills required, installation time, seal testing and cost impact. These devices and methods include welding, brazing, leading, adhesives and compression devices including clamps and sleeves with external mechanical compression means and internal seals such as “O” rings, lip seals, and compression bands. This invention was developed to obviate the limitations of prior sealing devices and methods and provide a sealing device and method that can be used by all industries to join and seal pipes and valves of all sizes, types, fluid contents, line pressures with greater ease and speed of installation, improved sealing characteristics at lower costs.

### BRIEF SUMMARY OF THE INVENTION

The object of this self-pressurizing seal invention is to obviate the inherent disadvantages of the slow, dangerous, and expensive process of welding to join and seal pipes valve of all sizes and pressures and to obviate the inherent disadvantages and seal limitations of other external and internal compression pipe connection sealing methods. This multi-combed self-pressurizing seal embodies an internal pressure responsive chamber whereby fluid escaping from a pipe juncture or center of a valve body flows into the seal's pressure responsive chamber whereby the trapped fluid expands outwardly with increasingly greater force against the exterior surface of multiple, pliable and conjoined ridges to form a series of redundant circumferential seals along the axial surface of pipes joined in a coupling device or valve body. As pressure increases within the internal pressure responsive chamber the corresponding external sealing force increases with greater pressure on the axial surface of the pipe to prevent the outward flow from a pipe juncture or valve body under fluid pressures.

### TECHNICAL PROBLEM

There have been very few advances in the field of joining and sealing pipes and valves of varying pipe sizes, pipe materials, fluid contents, line pressures, and environments with an improved sealing method and lower cost solution. The process of joining and sealing pipes and valves requires different devices and methods according to pipe size, pipe material, fluid contents, line pressure, and environments. Most pipe join and valve connection devices are difficult and costly to install, require specialist equipment, skilled labor, present safety and hazards to installers and the environment, and are prone to eventual seal failure and fluid leakage.

The welding process is currently used to join and seal larger pipes. The welding process is time consuming and labor intensive, hazardous to personnel and the environment, and requires specialist equipment and skilled labor that contributes to almost half the average costs of pipeline construction. Costs to seal pipes and pipes to valves increase incrementally according to the environment, size of pipes to be joined, setup time required prior to welding, fluid contents and line pressure. The welding process leads to leaks due to exterior and interior corrosion at the welded pipe join seam and pipe to valve connections. The welding process burns away the pipes protective coating at the pipe end. Interior corrosion of pipe joins can be caused by exposed metal to corrosive fluid contents such as crude oil and certain gases, which leads to eventual fluid leakage and environmental damage, costly repair and restoration. Repair of leaking or damaged pipes requires system shut-down, degassing, cutting, welding, and replacement of pipe sections which is a time consuming, labor intensive, dangerous, and expensive process.

The joining and sealing of pipes and pipes in valves using clamping devices and compression devices and seals with ‘o’ rings or compression sleeves is limited to smaller pipe sizes and lower line pressures and their “o” ring and compression seals are prone to damage and dislodgement during pipe insertion, dislodgement during compression, and tend to move axially in outward direction as line pressure increases. Large external compression clamps are heavy, require structural support, and requires special equipment and personnel to install.

Bolted flange assemblies and seals are relatively heavy, require additional space and structural support, and require more labor and equipment to install which increases costs and extends time to completion of installation. In the ship construction bolted flange pipe connections and pipe to valve connections and seals add several thousand tons to vessel displacement thereby reducing cargo capacity, fuel consumption, and increasing costs.

### SOLUTION TO PROBLEM

This multi-combed self-pressurizing seal invention obviates other devices and methods of sealing pipes and valves of all sizes, fluids and line pressures. This multi-combed self-pressurizing circumferential seal invention used in pipe couplings and valve bodies replaces welding as the primary method of sealing joined pipes using a pipe coupling device and sealing pipes in valve bodies used in the oil and gas pipeline industry, and in the construction, plumbing, maritime and ship building industries where welding, clamping, and compression sleeves and wraps are used in joining pipes and pipes to valves. This self-pressurizing seal invention embodies a resilient non-corrosive and fire resistant material, an internal pressure responsive chamber and sealing surface of multiple, pliable and conjoined ridges that form a series of redundant circumferential seals around the axial surface of pipe within a pipe coupling or a valve body with improved sealing characteristics to stop the outward axial flow of fluids forma pipe or valve.

### ADVANTAGEOUS EFFECTS OF INVENTION

This invention provides significant advantages in terms of installation speed, sealing performance and costs of installation over all prior means of sealing pipe joins and valves of all sizes, materials, fluid contents, and line pressures. This self-pressurizing sealing method replaces the slow, labor intensive and costly pipe join and sealing process of welding used to join larger pipe diameters, and to replace welding, brazing, leading, adhesives, compounds, liquids, and external clamping and internal compression devices and seals used to join and seal pipes in smaller diameter pipes industries. This self-pressurizing seal provides significantly faster installation, reduces safety and environmental hazard risks, at substantially lower costs than prior devices and methods used to join and seal pipes and valves.

This multi-combed self-pressurizing and self-sealing seal invention seals pipe joins and valves in substantially less installation time with better sealing performance of current devices and methods and has been pressure tested to seal pipes and valves to pressures exceeding 8,702 PSI or 600 BAR.

### BRIEF DESCRIPTION OF THE DRAWINGS

The invention is described in further detail with reference to the drawings which represent the embodiments of the invention. Structural details are illustrated only for fundamental understanding of the invention.

### Described in the Drawings:

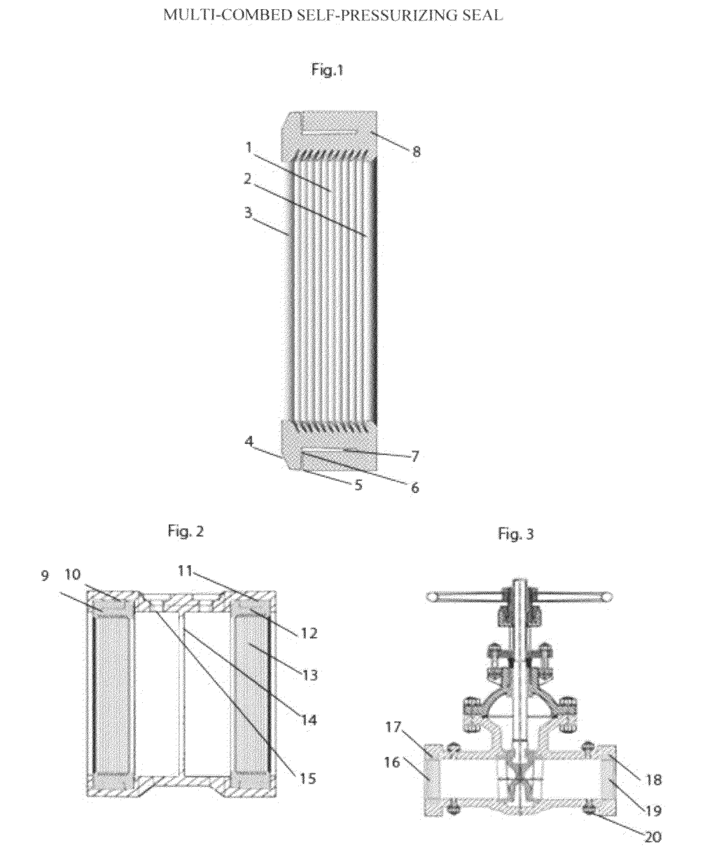

FIG. 1 A vertical cross-sectional view of the self-pressurizing and self-sealing seal illustrating the left inside edge of the seal and the right outside edge of the seal and a) the external pliable multi-combed sealing surface; b) the tapered edge located at the top inside edge of the seal body to facilitate upward compression and closing of the fluid inlet orifice leading to the pressure responsive chamber; c) a decreasing v-shaped unidirectional fluid inlet orifice extending circumferentially around the exterior recessed sea groove face into the internal pressure responsive chamber

FIG. 2 A horizontal cross-sectional end-view of a pipe coupling illustrating two self-pressurizing seals a) installed in recessed seal grooves located at the right outside edge of the coupling body;

FIG. 3 A horizontal cross-section of a pipe valve with two multi-combed self-pressurizing seals installed in recessed seal grooves located on the outside edges of the valve body.

### DETAILED DESCRIPTION OF THE INVENTION

The invention will now be described in further detail to the accompanying drawings, which represent by example embodiments of the invention. Structural details are shown only as far as necessary for a fundamental understand thereof The described example, together with the accompanying drawings, will make apparent to those skilled in the art and field how further forms of the invention may be realized.

### Described in the Drawings:

In FIG. 1 is seen a vertical cross-section illustrating the left inside edge of the seal and the right outside edge of the seal which are installed in the recessed seal grooves located on the outside edges of a pipe coupling body. The multi-combed self-pressurizing seal invention embodies multiple pliable conjoined ridges 1 extending from the outside edge 2 across the external face of the seal body to the inside edge of the seal 3 to form a series of redundant circumferential seals around the axial surface of pipe to prevent the outward flow of fluids from the pipe juncture within a pipe coupling juncture or valve body. As a pipe section is inserted into a pipe coupling or valve body from the outside edge of the seal, the multiple conjoined and pliable ridges of the sealing surface 1 compress inwardly toward the center of the coupling body and upwardly into the pliable and resilient body of the seal to protect the multiple and conjoined seal ridges from damage or seal body from dislodgement from the recessed seal groove in the outside edges of a pipe coupling or valve body. Once pressure is introduced into the pipe coupling juncture or valve body the pressure coefficient of escaping fluid from the pipe juncture or valve migrates outwardly along the axial surface of a pipe to the inside edge of the seal 3 whereby the fluid is directed into the recessed seal groove and travels over the chamfered inside hinged section 4 of the seal and enters the unidirectional inlet orifice 5 located inside the recessed seal groove and extends vertically into a decreasing sized orifice 6 into internal pressure responsive chamber 7 whereby trapped fluid under pressure expands outwardly to force external surface of multiple conjoined ridge 1 seals against the axial surface of the pipe with increasing pressure and seal integrity. This same outward expansion of the internal pressure responsive chamber simultaneously expands the seal body within the recessed seal groove with greater force as pressure increases to prevent dislodgement or leakage. The self-pressurizing seal is manufactured of resilient natural and synthetic materials 8 which are specifically formulated to resist seal degradation by caused by corrosive fluid elements and contains a fire retardant to prevent seal failure in the case extreme temperatures. Seals are color-coded according to identify specific fluid applications.

FIG. 2 shows a horizontal cross-sectional view illustrating the self-pressurizing seal invention installed in each outside edge of a pipe coupling. The self-pressurizing seal 9 resides in a recessed seal groove 10 on the left outside edge of the pipe coupling and a recessed seal groove 11 on the opposite outside right edge of the pipe coupling with the self-pressurizing seal 12 installed in each recessed seal groove. As pipe sections are inserted into each opposite side of the pipe coupling the multiple, conjoined and pliable ridges 13 of the seal compress inwardly toward the center pipe juncture 14 of the coupling and upwardly into the pliable and resilient body of the seal 12 to protect the multiple and conjoined seal ridges from damage or dislodgement of the seal from the recessed seal grooves 10, 11. Pipes inserted into opposite sides of the pipe coupling are then secured by bolts 15 with sealing washers.

FIG. 3 shows a horizontal cross-sectional view illustrating the self-pressurizing seal invention installed in each outside edge of a valve. The self-pressurizing seal invention 16 is installed in a recessed seal groove 17 on the left outside edge of the valve body and another recessed seal groove 18 located on the opposite outside edge of the valve body. The self-pressurizing seal invention is shown 19 installed in the recessed seal grooves 16, 17. As pipes are inserted into each opposite side of the valve body the multiple, conjoined and pliable ridges compress inwardly toward the center of the valve body and upwardly into the resilient body of the seal to protect the multiple and conjoined seal ridges from damage, dislodgement of the seal from the recessed seal grooves 17, 18 located at each outside edge of the valve. Pipes inserted into opposite side of the valve are secured using bolts 20 with washers.

### INDUSTRIAL APPLICABILITY

This multi-combed self-pressurizing seal invention has industrial applications in several industries where pipes must be joined and pipes connected and sealed in valves.

This multi-combed self-pressurizing seal invention can be used in the oil and gas industry to join pipes and connect valves that carry all types of fluids and pressures in surface, subsurface and subsea pipeline construction applications, to join pipes, and pipe and valve assemblies in oil and gas pumping station construction and repair, oil and gas refinery construction and repair, and oil and gas exploration rigs. The multi-combed self-pressurizing seal invention provides joining of pipes and connecting valves with substantially faster and easier installation, at lower risks to safety and the environment, and at significantly lower costs and faster time to construction completion.

This multi-combed self-pressurizing seal invention can be used to join pipes and valves in the plumbing, heating and air conditioning industry to join pipes of all sizes, fluid contents, temperatures and pressures to provide greater ease and speed of installation, safety, and lower costs.

This pipe coupling invention can be used in the maritime industry in ship construction industry to connect pipes and valves through the vessels including but not limited to water, steam, oil, and cargo. The multi-combed self-pressurizing seal invention can be used to replace heavy flange assemblies used in construction of vessel piping systems to substantially reduce overall vessel displacement, decrease fuel consumption, and increase tonnage.

We claim:

1. A self-pressurizing seal embodying multiple and conjoined pliable ridges which upon insertion of a pipe into a coupling or valve body compress inwardly and upwardly to prevent seal surface damage or dislodgement from the coupling device or valve body and simultaneously form a series of circumferential frictional seals prior to fluid pressure introduction.

2. A self-pressurizing seal embodying a unidirectional orifice extending vertically from the outside radial surface of the seal body and extending vertically into a decreasing orifice size whereupon entering the internal pressure responsive chamber trapped fluid expands the chamber outwardly across the external sealing surface of multiple and conjoined pliable ridges form a series of redundant seals.

2. Pliable and resilient seals manufactured of resilient natural and synthetic materials which are corrosion resistant to fluid elements and flame retardant to prevent seal failure in cases of highly corrosive fluids, extreme pressures, and temperatures, and which are color-coded to designate the material compositions of the seal for specific fluid applications.
